(19) United States
(12) Patent Application Publication
(10) Pub. No.: US 2016/0031281 A1
(43) Pub. Date: Feb. 4, 2016

(54) INFLATABLE AIR RESERVOIR

(71) Applicant: GM GLOBAL TECHNOLOGY OPERATIONS LLC, Detroit, MI (US)

(72) Inventors: Peter J. Soles, Tecumseh (CA); Scott R. Pouls, Waterford, MI (US)

(21) Appl. No.: 14/445,560

(22) Filed: Jul. 29, 2014

(51) Int. Cl. B60G 11/27

(52) U.S. Cl. CPC B60G 11/27; B60G 2202/152; B60G 2202/30

(57) ABSTRACT

An air suspension system includes a rigid frame member defining an unsealed fixed volume. An air reservoir is disposed within the fixed volume and variably occupies the fixed volume. The air reservoir includes a flexible bladder expandable between an unfilled volume, a first filled volume, and a second filled volume larger than the first filled volume. The first filled volume and the second filled volume at least partially expand into the fixed volume of the rigid frame member. A fill port is formed in one end of the flexible bladder and provides access to the expandable volume. A feed tube is disposed through the fill port into the expandable volume and is in airflow communication with the expandable volume. At least one air spring is in airflow communication with the air reservoir.

### TECHNICAL FIELD

This disclosure relates to air suspensions and, more specifically, air reservoirs for air suspensions.

### BACKGROUND

Some vehicles utilize air suspensions having air springs or pneumatic springs to provide relative motion between the chassis of the vehicle and the wheels. Generally, air suspensions utilize air in lieu of conventional, mechanical springs and other suspension components.

### SUMMARY

An air suspension system, such as those usable with a vehicle, is provided. The air suspension system includes a rigid frame member defining a fixed volume, which is unsealed. An air reservoir is disposed within the fixed volume and variably occupies the fixed volume.

The air reservoir includes a flexible bladder expandable between an unfilled volume, a first filled volume, and a second filled volume larger than the first filled volume. The first filled volume and the second filled volume at least partially expand into the fixed volume of the rigid frame member. A fill port is formed in one end of the flexible bladder and provides access to the expandable volume.

The air reservoir also includes a feed tube disposed through the fill port into the expandable volume and in airflow communication with the expandable volume. At least one air spring is in airflow communication with the air reservoir.

The above features and advantages, and other features and advantages, of the present subject matter are readily apparent from the following detailed description of some of the best modes and other embodiments for carrying out the disclosed structures, methods, or both.

### BRIEF DESCRIPTION OF THE DRAWINGS

FIG. 1 is a schematic diagram of an air suspension or air spring system for a vehicle;

FIG. 2 is a schematic, isometric view of an inflatable air reservoir disposed within a box-frame;

FIG. 3 is a schematic, partial cross section of the inflatable air reservoir, illustrated in one or more filled states;

FIG. 4 is a schematic, partial cross section of the inflatable air reservoir shown in FIG. 3, illustrated in an unfilled state;

FIG. 5 is a schematic, partial cross section of an end-mounted inflatable air reservoir, illustrated in a filled state; and

FIG. 6 is a schematic, partial cross section of a double-plug inflatable air reservoir having a feed tube with an acute angle.

### DETAILED DESCRIPTION

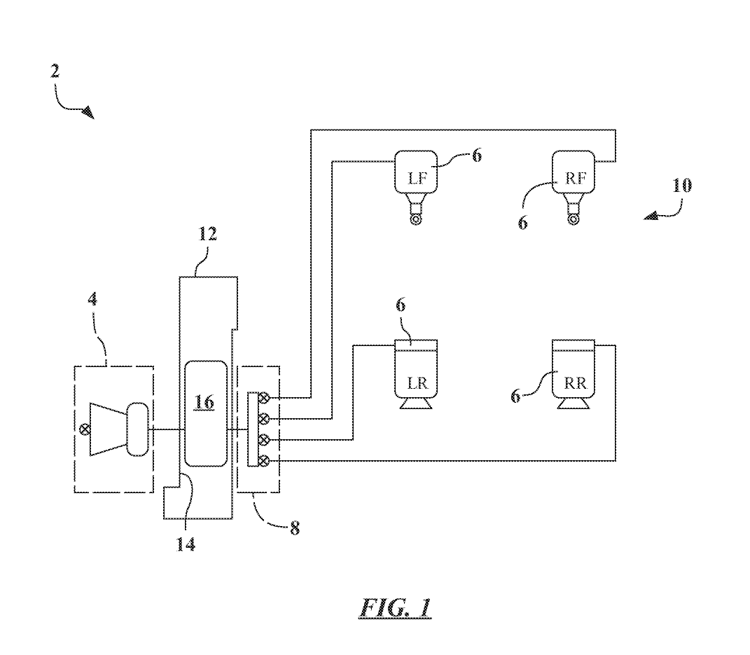

Referring to the drawings, like reference numbers correspond to like or similar components wherever possible throughout the several figures. FIG. 1 shows a diagrammatic view of a vehicle 2 having an air suspension system 10. The diagram is highly schematic and several elements shown are representative of multiple components.

A compressor assembly 4 supplies pressurized air to a plurality of air springs 6 through one or more valves in a valve assembly 8. As shown in FIG. 1, the air suspension system 10 also includes an air reservoir 16, which stores pressurized air for use by the air springs 6. The air suspension system 10 may be open or closed and the air springs 6 may include additional pneumatic components, such as dampers.

The air springs 6 receive pressurized air from the air reservoir 16, and possibly directly from the compressor assembly 4, to adjust the height of the vehicle 2 relative to the road surface by adjusting the air suspension system 10. The compressor assembly 4 and the valve assembly 8 may be operated by a control system (not shown), and the air springs 6 may return pressurized air to the air reservoir 16.

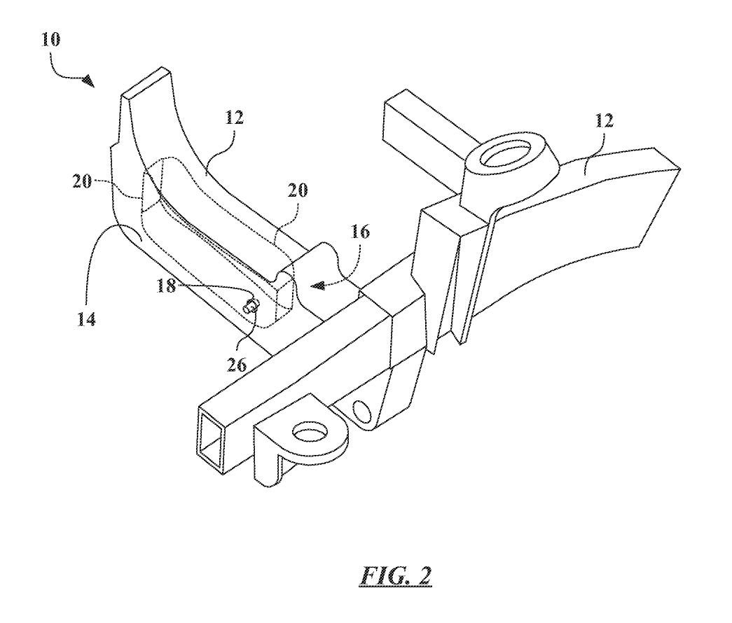

Referring also to FIG. 2, and with continued reference to FIG. 1, there is shown a schematic isometric view of a portion of the air suspension system 10. A rigid frame member 12 of the vehicle 2 defines a fixed volume 14, which is not sealed or airtight. The air reservoir 16 is disposed within the fixed volume 14, such that the air reservoir 16 occupies a portion of space within the chassis or body of the vehicle 2. An access hole 18 is formed in some portion of the rigid frame member 12. As described herein, the access hole 18 may provide an insertion or installation point for the air reservoir 16.

The rigid frame member 12 shown in FIG. 2 is a section or segment of a body-on-frame chassis. In many configurations, the rigid frame member 12 may be significantly longer or larger than that shown in FIG. 2 and the air reservoir 16 may occupy more or less of the fixed volume.

The rigid frame member 12 may be, for example and without limitation: a structural element of a body-on-frame chassis, a body-frame-integral chassis, or a chamber within a body panel. In many configurations, the rigid frame member 12 is a load-bearing or supporting member of the vehicle 2. Regardless of the primary function of the rigid frame member 12, it is an otherwise-structural element that defines the fixed volume 14 in which the air reservoir 16 is at least partially disposed. The fixed volume 14 is unsealed, such that it could not act as a reservoir for the air spring system 10.

While the systems may be described with respect to automotive or vehicular applications, those skilled in the art will recognize broader applicability. Those having ordinary skill in the art will recognize that terms such as “above,” “below,” “upward,” “downward,” et cetera, are used descriptively of the figures, and do not represent limitations. Any numerical designations, such as “first” or “second” are illustrative only and are not intended to be limiting.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting of the claims or the description.

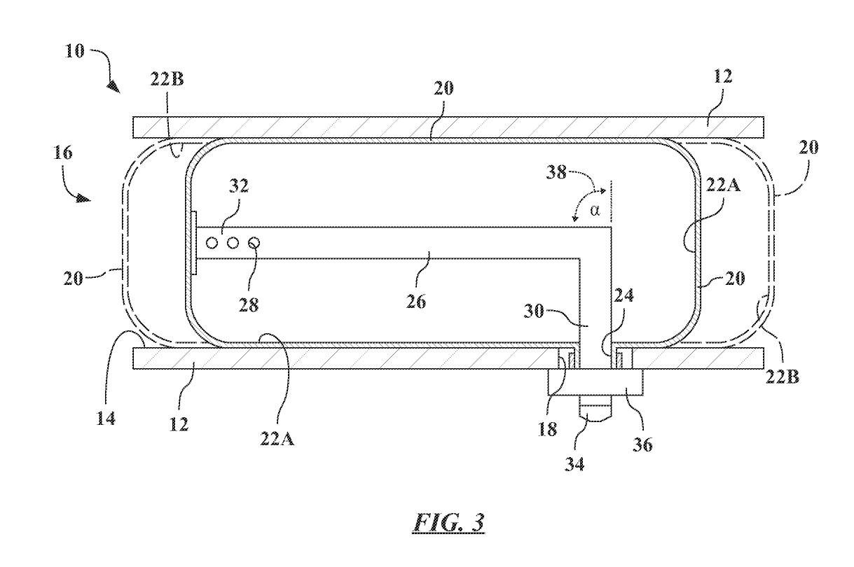

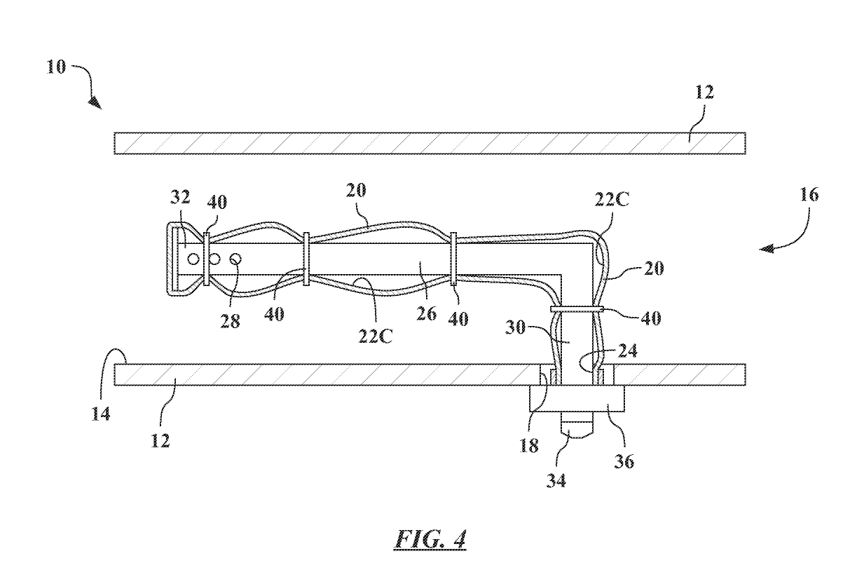

Referring to FIG. 3 and to FIG. 4, and with continued reference to FIGS. 1-2, there are shown additional views of portions of the air suspension system 10 shown in FIG. 2. FIG. 3 shows a schematic, partial cross-sectional view of the rigid frame member 12 and the air reservoir 16 in one or more filled states, and the FIG. 4 shows the air reservoir 16 in an unfilled state, such as that existing during assembly to the rigid frame member 12.

In the air suspension system 10 shown, a flexible bladder 20 is disposed within the fixed volume 14 of the rigid frame member 12. The rigid frame member 12 and the flexible bladder 20 are show sectioned to illustrate the remaining components of the air reservoir 16. The rigid frame member 12 shown may be only a portion of the chassis or frame section into which the air reservoir 16 is disposed.

The flexible bladder 20 defines an expandable volume that is expandable between at least a first filled volume 22A and a second filled volume 22B from an unfilled volume 22C. The first filled volume 22A is illustrated in FIG. 3 as defined by the flexible bladder 20 in solid lines, and the second filled volume 22B is illustrated in FIG. 3 as defined by the flexible bladder 20 in dashed or phantom lines. The unfilled volume 22C is illustrated in FIG. 4 as defined by the flexible bladder 20 in solid lines.

The second filled volume 22B may be at least two times larger than the first filled volume 22A and at least ten times larger than the unfilled volume 22C. As the flexible bladder 20 expands from the unfilled volume 22C to the first filled volume 22A and to the second filled volume 22B, the flexible bladder 20 progressively occupies more of the otherwise unusable void within the rigid frame member 12.

Note that the relative sizes of the components shown in the figures are schematic and illustrative, but may not match the actual relative dimensions of the rigid frame member 12 or the flexible bladder 20 used in the air reservoir 16. All of the volumetric states shown in FIGS. 3 and 4 may be referred to generically as the expandable volume, as all of the states or volumes are defined by expansion and contraction of the flexible bladder 20.

A fill port 24 is formed in one end of the flexible bladder 20. The fill port 24 provides access to the expandable volume, and the flexible bladder 20 may be oriented such that the fill port 24 is substantially adjacent to the access hole 18 of the rigid frame member 12.

A feed tube 26 is disposed through the fill port 24 into the expandable volume. The feed tube 26 is in airflow communication with the expandable volume, such that air may be removed from, or added to, the flexible bladder 20 via the feed tube 26. At least a portion of the feed tube 26 is hollow, and one or more flow holes 28 or ports may be formed in the feed tube 26.

The feed tube 26 has a fill end 30 formed on one end thereof and a push end 32 formed opposite the fill end 30. The fill end 30 is substantially sealed to the fill port 24 of the flexile bladder 20. The push end 32 is disposed within the expandable volume. The flow holes 28 are illustrated as defined in the push end 32 but may be disposed along additional portions of the feed tube 26.

FIG. 3 illustrates the expandable volume of the flexible bladder 20 in the first filled state or first filled volume 22A in solid lines and illustrates the expandable volume of the flexible bladder 20 in the second filled state or second filled volume 22B with dashed or phantom lines. FIG. 4 illustrates the expandable volume of the flexible bladder 20 in the unfilled state or unfilled volume 22C, which may be used for installation of the air reservoir 16 into the rigid frame member 12.

During assembly of the air suspension system 10, the air reservoir 16 may be installed or inserted into the fixed volume 14 of the rigid frame member 12 while the flexible bladder 20 is at the unfilled volume 22C (as illustrated in FIG. 4). While deflated to the unfilled volume 22C, the air reservoir 16 may be guided through the access hole 18 with the flexible bladder 20 wrapped around, or held against, the feed tube 26. Therefore, at least when the flexible bladder 20 is deflated to the unfilled volume 22C, the air reservoir 16 fits through the access hole 18 and into the fixed volume 14, which allows the air reservoir 16 to selectively expand into, and occupy, otherwise-unusable portions of the rigid frame member 12.

In some configurations of the air reservoir 16, the push end 32 of the feed tube 26 may be attached to the flexible bladder 20 opposite the fill port 24, which may assist in inserting the flexible bladder 20 into the fixed volume 14. An air fitting 34 and a mounting plate 36 may assist in assembly of the air reservoir 16 to the rigid frame member 12 and communication with the remainder of the air suspension system 10. The flexible bladder 20 may be crimped or clamped to the feed tube 26 or may be held and sealed to the feed tube 26 as part of the air fitting 34 or mounting plate 36.

As shown in FIGS. 3 and 4, the push end 32 of the feed tube 26 is at an angle 38, which is at least forty-five degrees, to the fill end 30. More specifically, the angle 38 is substantially ninety degrees between the push end 32 and the fill end 30 in the configuration illustrated in FIGS. 3 and 4.

The flexible bladder 20 may be held to the feed tube 26 for installation into the fixed volume 14 of the rigid frame member 12. As illustrated in FIG. 4, the air reservoir 16 may have at least one sacrificial band 40 disposed around the flexible bladder 20. The sacrificial bands 40 are configured to restrain the flexible bladder 20 to the unfilled volume 22C during installation, but then to be broken as the flexible bladder 20 expands to the first filled volume 22A.

The sacrificial bands 40 may be formed from, for example and without limitation: plastic, rubber, thin metal straps, or other materials configured to break as the flexible bladder 20 expands. The sacrificial bands 40 may also include joints or other localized areas designed to facilitate breaking of the sacrificial bands 40 as the flexible bladder 20 expands.

After the sacrificial bands 40 break, the flexible bladder 20 expands to the first filled volume 22A and then to the second filled volume 22B, which is substantially restrained by the rigid frame member 12 and constrained within a portion of the fixed volume 14. The flexible bladder 20 shown in FIGS. 3 and 4 has an elongated shape, and may form a cylinder or rectangular tube when free to expand without restraint.

The flexible bladder 20 may be formed from various materials, including, for example and without limitation, fiber-reinforced rubber. Reinforcement fibers may include, for example and without limitation: aramid, glass, or polyester. The flexible bladder 20 may be formed from non-corroding materials to limit corrosion between the rigid frame member 12 and the air reservoir 16, including galvanic or other electrochemical corrosion that may occur between metals. The flexible bladder 20 is an alternative to rigid, fixed-volume tanks, such as those formed from steel, aluminum, or other metals.

The feed tube 26 may be formed from, for example and without limitation: steel, aluminum, stiff rubber, or plastic. The feed tube 26 may be substantially rigid or may be flexible, in order to ease installation when the fixed volume 14 has limited space or odd angles relative to the access hole 18 or other access areas or points. Note that FIGS. 3 and 4 are highly illustrative, such that the rigid frame member 12 is shown with very basic shape. However, the rigid frame member 12 may have protrusions into the fixed volume 14 and portions extending away from the flexible bladder 20, around which, and into which, the flexible bladder 20 will conform.

The flexible bladder 20 will conform to the shape of the fixed volume 14 within the rigid frame member 12 when inflated, such as the more-complex shape illustrated in FIG. 2. As illustrated in FIG. 3, when the flexible bladder 20 is inflated to the first filled volume 22A, it fills a portion of the fixed volume 14 and the rigid frame member 12 provides some counter force opposing the pressurized air within the expandable volume.

Therefore, the rigid frame member 12 may provide some structural support for the air reservoir 16, without affecting the load-bearing or structural functionality of the rigid frame member 12 within the vehicle 2. Furthermore, the flexible bladder 20 is capable of contouring to the shape of the fixed volume with the rigid frame member 12. Contrarily, metal tanks used as air reservoirs provide substantially all of the force countering the interior pressure and are unable to alter shape or contour within structural members.

In some configurations of the air reservoir 16, the fixed volume 14 of the rigid frame member 12 may greatly exceed the size of the first filled volume 22A or the second filled volume 22B, such that the flexible bladder 20 may have little contact with any walls of the rigid frame member 12 other than portions adjacent the access hole 18. In other configurations of the air reservoir 16, the fixed volume 14 of the rigid frame member 12 may be substantially filled by the flexible bladder 20 as it reaches the second filled volume 22B, such that all available space is used and the flexible bladder 20 is closely contoured to the shape of the fixed volume 14. Note however, that the flexible bladder 20 is sealed and the rigid frame member 12 is unsealed, such that the fixed volume 14 could not be used as an air reservoir on its own, without the flexible bladder 20.

The flexible bladder 20 and feed tube 26 allow the air reservoir 16 to be packaged largely within otherwise unusable space. Rigid metallic tanks are generally attached to the underside of vehicles and occupy volumetric space usable for other vehicle components. However, the air reservoir 16 may occupy the otherwise unusable space within the rigid frame member 12.

The rigid frame member 12 may provide some protection from road debris or objects that could puncture the flexible bladder 20. Therefore, the air reservoir 16 uses the rigid frame member 12 to structurally support the flexible bladder 20 and also to protect the flexible bladder 20.

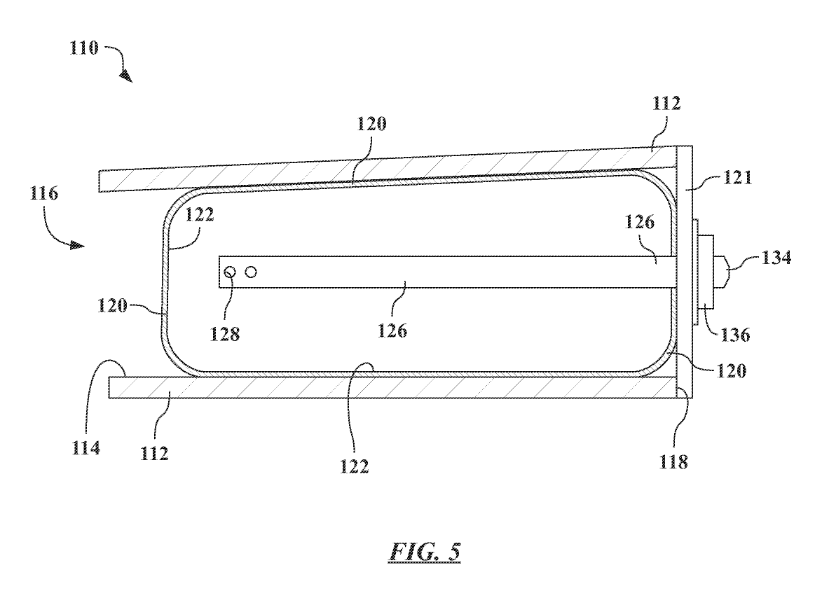

Referring now to FIG. 5, and with continued reference to FIGS. 1-4, there is shown a schematic isometric view of a portion of an air suspension system 110. A rigid frame member 112 of a vehicle (not shown) defines a fixed volume 114, which is not sealed or airtight. The air reservoir 116 is disposed within the fixed volume 114, such that the air reservoir 116 occupies a portion of space within the chassis or body of the vehicle.

The air reservoir 116 has a flexible bladder 120 disposed within the fixed volume 114. The air reservoir 116 has an end-mounted configuration such that the rigid frame member 112 does not require an access hole and the flexible bladder 120 may be mounted by insertion or installation through an open end 118 of the rigid frame member 112. The air reservoir 116 may be disposed loosely within the fixed volume 114 or may attached to the open end 118 with a cap or bracket 121, as illustrated.

The flexible bladder 120 defines an expandable volume 122 and a feed tube 126 extends into the expandable volume 122. The feed tube 126 may be substantially straight (as shown in FIG. 5) or may be angled, depending upon the structures around the rigid frame member 112. The feed tube 126 has flow holes 128 providing airflow communication with the expandable volume 122. An air fitting 134 and a mounting plate 136 may assist in assembly of the air reservoir 116 to the rigid frame member 112.

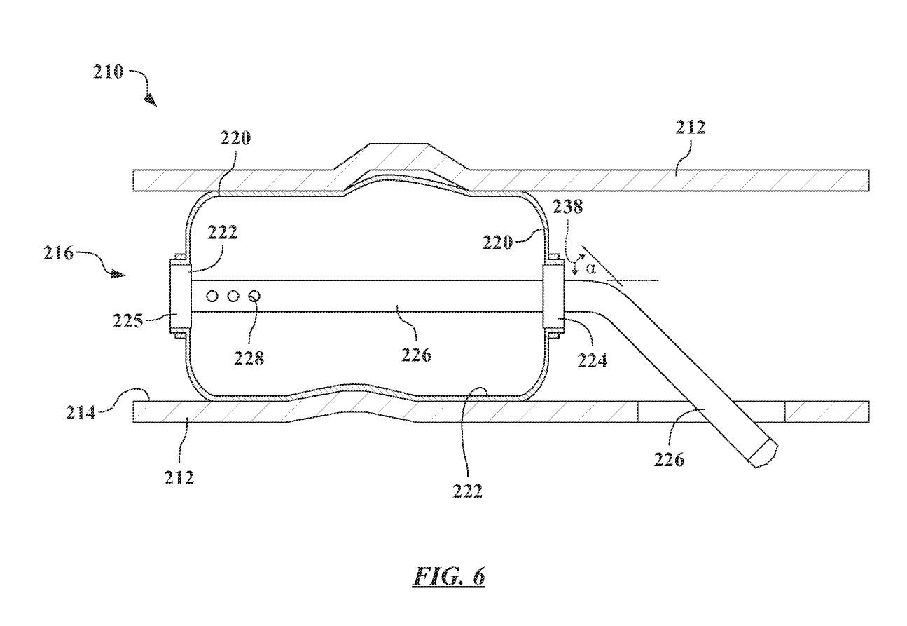

Referring now to FIG. 6, and with continued reference to FIGS. 1-5, there is shown a schematic isometric view of a portion of an air suspension system 210. A rigid frame member 212 of a vehicle (not shown) defines a fixed volume 214, which is not sealed or airtight. The air reservoir 216 is disposed within the fixed volume 214, such that the air reservoir 216 occupies a portion of space within the chassis or body of the vehicle.

The air reservoir 216 has a flexible bladder 220 disposed within the fixed volume 214. The flexible bladder 220 defines an expandable volume 222 between a fill port 224 and an end plug 225. A feed tube 226 extends through the fill port 224 into the expandable volume 222 and has flow holes 128 to provide airflow communication with the expandable volume 222. The fill port 224 also includes plug structure.

As illustrated in FIG. 5, the air reservoir 216 has double-plug configuration such that the air reservoir 216 may not require an access hole formed in the rigid frame member. However, the feed tube 226 may be angled to allow the air reservoir to be inserted or installed though limited space and into the rigid frame member 212. The feed tube 226 is shown at an angle 238 of between approximately 30-45 degrees as it extends to the flexible bladder 220.

As used herein, the term substantially refers to quantities, values, dimensions, or alignments that are within manufacturing variance or tolerance ranges of being exact. Substantially equal dimensions, for example, may be planned as ideally equal but normal manufacturing tolerances may cause the resulting dimensions to vary by 10-20% for different pieces. Substantially aligned, for example, refers components that are intended to be truly aligned but may be slightly offset when assembled under real world manufacturing conditions.

The detailed description and the drawings or figures are supportive and descriptive of the subject matter discussed herein. While some of the best modes and other embodiments for have been described in detail, various alternative designs, configurations, and embodiments exist.

1. An air suspension system, comprising:
a rigid frame member defining a fixed volume, wherein the fixed volume is unsealed;
an air reservoir disposed within the fixed volume, including:
a flexible bladder expandable between an unfilled volume, a first filled volume, and a second filled volume larger than the first filled volume, wherein the first filled volume and the second filled volume at least partially expand into the fixed volume of the rigid frame member;
a fill port formed in one end of the flexible bladder and providing access to the expandable volume; and
a feed tube disposed through the fill port into the expandable volume and in airflow communication with the expandable volume; and
at least one air spring in airflow communication with the air reservoir.

2. The air suspension system of claim 1, further comprising:
an access hole defined in the rigid frame member, wherein the air reservoir is configured to be installed through the access hole via the feed tube when the flexible bladder is at the unfilled volume.

3. The air suspension system of claim 2, further comprising:
at least one sacrificial band disposed around the flexible bladder, wherein the sacrificial band is configured to restrain the flexible bladder to the unfilled volume and to break as the flexible bladder expands from the unfilled volume to the first filled volume.

4. The air suspension system of claim 3, wherein the flexible bladder is formed from fiber-reinforced rubber.

5. The air suspension system of claim 4, wherein the second filled volume is substantially constrained by the rigid frame member, such that the flexible bladder is contoured to the rigid frame member.

6. The air suspension system of claim 5, wherein the second filled volume of the flexible bladder is at least ten times larger than the unfilled volume.

7. The air suspension system of claim 6, wherein the feed tube of the air reservoir includes:
a fill end sealed to the fill port; and
a push end disposed within the expandable volume opposite the fill end, wherein the push end of the feed tube is at an angle of at least forty-five degrees to the fill end.

8. A vehicle, comprising:
a load-bearing member defining a fixed volume, wherein the fixed volume is unsealed;
an air reservoir disposed within the fixed volume of the load-bearing member, including:
a flexible bladder formed from fiber-reinforced rubber and expandable between an unfilled volume, a first filled volume, and a second filled volume at least two times larger than the first filled volume, wherein the flexible bladder contacts a portion of the load-bearing member when expanded to the first filled volume;
a fill port formed in one end of the flexible bladder and providing access to the expandable volume; and
a feed tube having a fill end sealed to the fill port, and a push end disposed within the expandable volume opposite the fill end, wherein the feed tube is in airflow communication with the expandable volume;
a compressor assembly configured to provide pressurized air to the air reservoir; and
a plurality of air springs in airflow communication with the air reservoir and configured to suspend the vehicle.

9. The vehicle of claim 8, further comprising:
at least one sacrificial band disposed around the flexible bladder, wherein the sacrificial band is configured to restrain the flexible bladder to the unfilled volume and to break as the flexible bladder expands from the unfilled volume to the first filled volume.

10. An air reservoir, comprising:
a flexible bladder defining an expandable volume, wherein the flexible bladder is expandable between an unfilled volume and a filled volume larger than the unfilled volume, such that the flexible bladder is configure to occupy at least a portion of a void;
a fill port formed in one end of the flexible bladder and providing access to the expandable volume; and
a feed tube sealed to the fill port and extending into the expandable volume, wherein the feed tube is in selective airflow communication with the expandable volume.

11. The air reservoir of claim 10, wherein the feed tube has:
a fill end sealed to the fill port; and
a push end disposed within the expandable volume opposite the fill end.

12. The air reservoir of claim 11, wherein the push end of the feed tube is at an angle of at least forty-five degrees to the fill end.

13. The air reservoir of claim 12, further comprising:
at least one sacrificial band disposed around the flexible bladder, wherein the sacrificial band is configured to restrain the flexible bladder to the unfilled volume and to break as the flexible bladder expands from the unfilled volume to the first filled volume.

14. The air reservoir of claim 13, wherein the filled volume of the flexible bladder is at least ten times larger than the unfilled volume.

15. The air reservoir of claim 14, wherein the push end of the feed tube is attached to the flexible bladder.
